(19) United States
(12) Patent Application Publication
(10) Pub. No.: US 2025/0031866 A1
(43) Pub. Date: Jan. 30, 2025

(54) Mattress Carrier Clamps

(71) Applicant: James Michael Gorst, Northwich (GB)

(72) Inventor: James Michael Gorst, Northwich (GB)

(21) Appl. No.: 18/765,718

(22) Filed: Jul. 8, 2024

Related U.S. Application Data
(60) Provisional application No. 63/529,279, filed on Jul. 27, 2023.

(51) Int. Cl. A47C 31/00; B65G 7/12

(52) U.S. Cl. CPC A47C 31/00; B65G 7/12

(57) ABSTRACT

The invention introduces mattress carrier clamps for lifting and transporting mattresses. The system comprises two clamps, one for each end of a mattress, consisting of pairs of arms with distal ends having paddles with rubber traction pads for engaging each side of the mattress. Opposing ends of the arms feature male and female connectors locking together to create a handle. When pressed together at the point nearest the user, the clamp securely grips the mattress by utilizing opposing force of mattress springs or foam. Upon releasing pressure, the clamp locks around the mattress allowing it to be lifted and carried via the handle. The clamps are easily adjustable and quickly removable. Made from materials such as steel, injection-molded plastic, or carbon fiber, the lightweight clamps are effective for moving bare and covered mattresses of various sizes.

### CROSS-REFERENCE TO RELATED APPLICATIONS

This non-provisional application claims the benefit of U.S. provisional application Ser. No. 63/529,279 filed Jul. 27, 2023, which is incorporated by reference herein.

### TECHNICAL FIELD OF THE INVENTION

The present invention generally relates to methods and means for moving mattresses. More particularly, the present invention relates to clamps used for lifting and transporting mattresses. Also, the present invention relates to a method for lifting and transporting mattresses using the mentioned clamps.

### BACKGROUND OF THE INVENTION

Mattresses come in all shapes and sizes and need to be moved to their location. Delivering or collecting a mattress involves the mattress being loaded and unloaded onto a vehicle and then the navigation through doorways, corridors, stairs and around corners to its final destination.

Moving and transporting a mattress can be a cumbersome task, as mattresses are often heavy, bulky, and awkward to handle. Traditional methods of moving mattresses involve a minimum of two people, one at each end to lift and maneuver the mattress, manually lifting the mattress by gripping its sides, which can be tiring, strain the back, and risk damage to the mattress. Additionally, mattresses need protection from dirt, moisture, and damage during transport, especially when moved across long distances or during inclement weather. The need for solutions to assist with the transport of mattresses has led to various inventions designed to facilitate lifting, carrying, and protecting mattresses during transportation.

The known ways to move a mattress other than by using your bare hands include frames, trollies, straps and bags with handles. However, frames and trollies are cumbersome to operate, straps and bags take a long time to apply and adjust whilst bags require additional space to load due to their size as well as presenting hygiene issues with used mattresses.

A review of the existing related patents in the art of the invention, which address different aspects of mattress transportation, reveals a variety of approaches ranging from simple lifting aids to protective covers and more complex mechanisms for facilitating the movement of mattresses.

US20210219740A1 introduces a cover designed primarily for protecting the mattress during transportation, with the added benefit of aiding in carrying. It provides a water-impermeable cover that can be used to hold the mattress in both folded and unfolded positions.

U.S. Pat. No. 8,459,710B1 offers a sling design that supports the mattress during transport. This patented carrier features multiple handles for ease of lifting and stabilizing straps to ensure secure transportation.

U.S. Pat. No. 4,521,045A describes a flexible cover that envelops the mattress for protection during transportation. It includes handles and reinforcing bands to assist in lifting and handling. The carrier also has an opening and closure system, including zippers and protective overlays.

EP3370575B1 presents a more complex mechanism for adjusting the position of panels in a mattress carrier. This patented device features adjustable panels, drive mechanisms, and positioning means, suggesting customization of mattress comfort or support.

U.S. Pat. No. 8,528,132B2 describes a mattress carrier designed to support the mattress with a level of resilience and compressibility. It includes a support surface, a second supporting part, and a specialized resilient insert.

US20190021515A1 is a protective and transport cover for the mattress. It provides protection and facilitates transport by enveloping the mattress, with straps to fold and secure it and multiple handles for lifting.

US2008104753A1 discloses a device for covering and facilitating the transport of a mattress, which includes a material cover which encloses the mattress, a zipper or other fastening means for closing the cover, a plurality of handles to allow the user to lift the mattress, and a plurality of wheels or casters to permit the user to move the enclosed mattress.

U.S. Pat. No. 9,067,734B1 discloses a carrier detachably engaging opposing ends of an unfolded and upright mattress and utilizing a pair of movers to move the unfolded and upright mattress. The carrier includes a pair of frames. The pair of frames detachably engage the opposing ends of the unfolded and upright mattress, respectively, and utilize the pair of movers to move the unfolded and upright mattress.

These related patent documents demonstrate a wide range of solutions to address the challenges of mattress transportation. However, each solution differs in its design, functionality, and primary purpose. Some focus on providing temporary handles for lifting, while others offer protection from external factors or incorporate more complex mechanisms for customization or support.

The present invention seeks to address the needs of mattress transportation in a novel way, considering the different approaches and drawbacks found in the related art. It aims to provide a solution that combines the best features of existing solutions while adding new, innovative elements for efficient and safe mattress handling. Particularly, there is a need to provide a solution for moving any mattress up to king size efficiently, which can be lifted and moved between two people at each end, within close proximity to surroundings and within short timeframes. A solution should allow quick removal or adjustment, be compact and lightweight and address hygiene issues with new and used mattresses. Also, a solution should be applicable to both bare and covered mattresses (such as a mattress in a plastic carrier bag or mattress bag).

### SUMMARY OF THE INVENTION

The present invention provides a mattress transportation device that addresses the mentioned challenges associated with moving mattresses while incorporating novel features not found in the prior art. It aims to provide a solution that combines support, convenience, and adaptability to different mattress sizes, resulting in a comprehensive system for the efficient and safe handling of bare and covered mattresses.

According to a first aspect of the invention, a mattress carrier clamp is provided, comprising: a pair of arms, each arm having a distal end and an opposing end; a paddle attached to the distal end of each arm, each paddle having a surface with a rubber traction pad; opposing male connector and female connectors located at the opposing ends of the arms; a handle formed by the male connector threading through the female connectors; wherein the paddles are configured to be placed on either side of one end of a mattress, and when the arms are pressed together, the clamp is configured to grip the mattress and lock around it due to the opposing force of the mattress springs or foam, allowing for lifting and carrying the mattress via the handle.

In one of the embodiments, the male connector is positioned at right angles to the arms.

In another one of the embodiments, the arms are made from ¾″ (about 19 mm) square box steel and measure approximately 8″ (about 20.3 cm) in length.

In another one of the embodiments, each of the paddles is made from fiberboard or plastic and measures approximately 7″×9″ (about 17.8×22.9 cm).

In another one of the embodiments, the male connector is a ⅝″ (about 15.8 mm) steel square bar approximately 1 foot (about 30.5 cm) in length, and each of the female connectors is a square ¾″ (about 19 mm) box steel section approximately 1.5″ (about 3.8 cm) in length.

In another one of the embodiments, the clamp is made from materials selected from the group consisting of steel, injection-molded plastic, and carbon fiber.

In another one of the embodiments, the clamp comprises plastic cap ends on the distal ends of the arms.

In another one of the embodiments, the paddles are attached to the arms using flat head bolts and nuts to keep the profile flush with the traction pads and the arms.

According to a second aspect of the invention, a method for lifting and transporting a mattress using the mattress carrier clamp of the first aspect of the invention is provided, comprising the steps of:
placing the mattress on its side;
positioning the paddles on either side of one end of the mattress;
pressing the arms together to compress the mattress;
releasing the arms to lock the clamps around the mattress;
lifting and transporting the mattress using the handle;
pressing the arms together at a point furthest from a user to release the clamp;
removing the clamp from the mattress.

According to a third aspect of the invention, a system for lifting and transporting a mattress between two people is provided, consisting of two mattress carrier clamps of the first aspect of the invention, one mattress carrier clamp for each end of the mattress.

The technical advantages associated with the present invention are as follows.

1. Support and stability. The mechanism offers stability to the mattress during transportation. This feature ensures that the mattress remains reliably supported, providing a more manageable and secure transport experience.

2. Ergonomic handling. The adjustable handles provide a comfortable grip and can be repositioned for easy lifting and carrying. This ergonomic design reduces the risk of strain or injury while transporting the mattress.

3. Ease of movement. The compact and lightweight mechanism with the handle allows the user to effortlessly move the mattress, which is especially advantageous for long distances or when navigating through tight spaces.

4. Versatility. The invention can be easily and quickly adjusted to fit various mattress sizes, from twin to king, making it a versatile solution for transporting any mattress.

5. Time and labor savings. The invention simplifies the process of moving mattresses, reducing the time and effort required compared to traditional methods. This advantage is especially beneficial for businesses involved in mattress delivery or moving services.

6. Durability. The invention is constructed from high-quality, water-resistant materials, ensuring its longevity and continued effectiveness over time. This feature makes it a cost-effective solution for frequent mattress transportation.

7. Improved customer experience. For businesses involved in mattress delivery or moving services, the invention provides a professional and efficient means of transporting mattresses. This can enhance customer satisfaction and potentially lead to increased customer loyalty and referrals.

In summary, the present invention offers numerous technical advantages, including ergonomic handling, support and stability during transportation, ease of movement, versatility, time and labor savings, durability, reduction in potential damages, and improved customer experience. These advantages make it a valuable solution for individuals and businesses alike.

### BRIEF DESCRIPTION OF THE DRAWINGS

The present invention will be described more fully hereinafter with reference to the accompanying drawings, in which prominent aspects and features of the present invention are illustrated, showcasing its design and functionality from various perspectives. The drawings as listed below are essential for understanding of the configuration, components, operation, application and advantages of the present invention.

FIG. 1 shows a top perspective view of a mattress carrier clamp according to an embodiment of the present invention, with two paddles of the clamp removed and not shown. It depicts an overall design of the clamp assembly and the relative positioning of its components, with the paddles being disconnected from respective first and second arms of the clamp and not shown. The illustration gives an overview of the clamp's shape and structure, revealing the key elements involved in its function.

FIG. 2 shows a side view of the mattress carrier clamp from FIG. 1, with a male connector being disconnected from a female connector of the first arm of the clamp, and without the two paddles of the clamp being attached. The depiction focuses on a lateral profile of the clamp components and provides a clear understanding of the clamp's relative dimensions, shape, and configuration from a side perspective.

FIG. 3 shows a front view of one of two paddles of the mattress carrier clamp from FIGS. 1 and 2, which is configured to be attached to the first arm and is identical to the second paddle configured to be attached to the second arm. The illustration highlights the holes present in the paddle for connection (using bolts and nuts) to the respective arm of the clamp and emphasizes the design of the paddle. The holes are essential for adjusting the clamp's position and securely gripping the mattress.

FIG. 4 shows a perspective view of two assembled mattress carrier clamps holding a mattress, each mattress carrier clamp being as shown in FIGS. 1 and 2 and comprising two paddles (each as shown in FIG. 3) attached to the respective first and second arms using bolts and nuts. This drawing presents the mattress carrier clamp in use. The image illustrates how the clamp securely grips the mattress, enabling easy transportation. The viewer can see how the clamp's components work together to provide a stable and efficient carrying solution for bare or covered mattresses.

For a complete understanding of the present invention parts, the following reference numerals are provided in the drawings: 1—a mattress carrier clamp; 2—a first arm (with a female connector); 3—holes for bolts of the first arm; 4—a distal end of the first arm; 5—a paddle of the first arm; 6—a hole for bolts in the paddle of the first arm; 7—an opposing end of the first arm; 8—a female connector of the first arm; 9—a second arm (with a female connector); 10—holes for bolts of the second arm; 11—a distal end of the second arm; 12—a paddle of the second arm; 13—a rubber traction pad on the paddle of the second arm; 14—an opposing end of the second arm; 15—a female connector of the second arm; 16—a male connector (handle) that threads through the female connectors of both arms; 17—a joint formed by the handle male connector and the female connector of the first arm; 18—plastic cap ends; 19—bolts and nuts, which are used to attach the paddles to the arms; 20—a mattress.

The present drawings relate to schematic drawings so that any dimension of the elements shown in the drawings may deviate from a specific implementation thereof.

These drawings, accompanied by their respective descriptions, offer a comprehensive visualization of the present invention and its components and enhance the reader's understanding of the invention's design, functionality, and advantages, providing a clear representation of the innovative solution it offers for mattress transportation.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention. For example, modifications of specific elements of the preferred embodiments described hereafter may be combined with other modifications so as to provide further embodiments of the present invention.

The mattress carrier clamps according to the present invention are designed for lifting and transporting a mattress between two people. The mattress carrier clamps according to the present invention can grip a bare mattress or a covered mattress, such as a mattress provided in a plastic carrier bag or mattress bag. For this purpose, the mattress carrier clamps consist of two separate clamps 1, one for each end of a mattress. Each mattress carrier clamp 1 has a pair of arms with distal ends, paddles, rubber traction pads, and connectors.

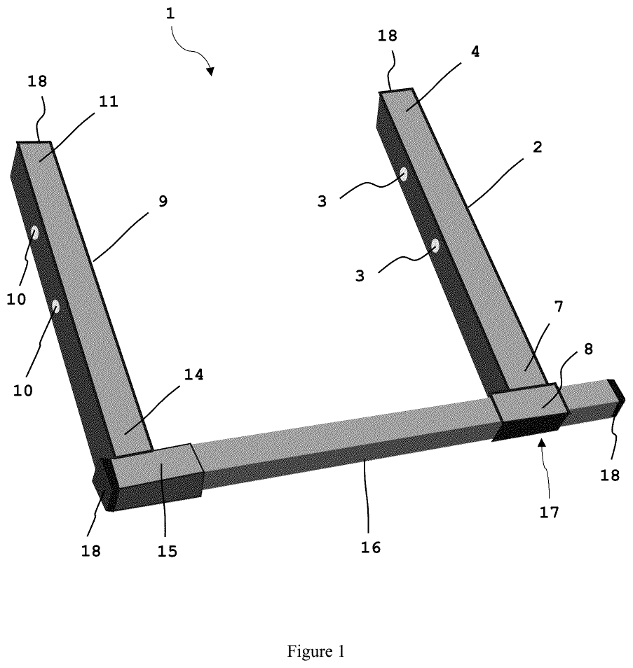

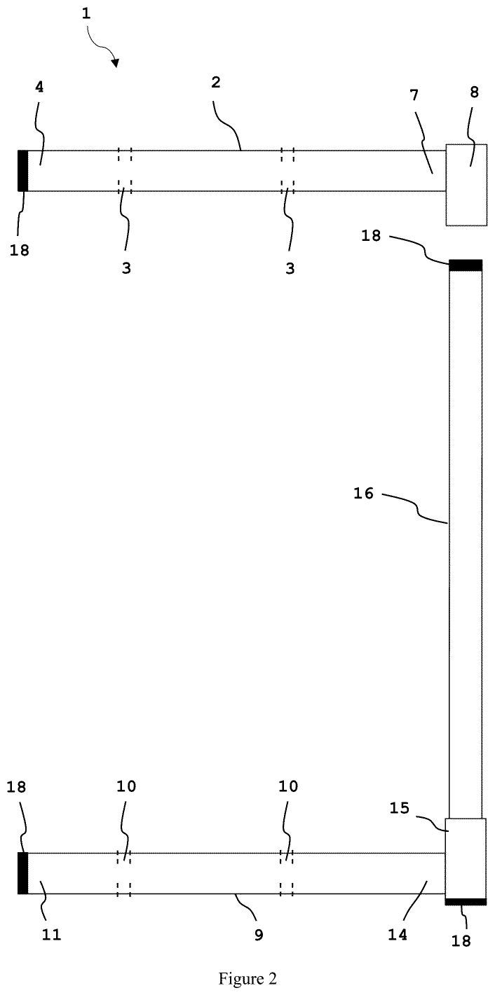

As shown in FIGS. 1 and 2, each clamp 1 has a first arm 2 and a second arm 9. The first arm 2 and the second arm 9 are square hollow bars. In a preferable embodiment, each of the first arm 2 and the second arms 9 is made from ¾″ (about 19 mm) square box steel, measuring approximately 8″ (about 20.3 cm) in length.

The first arm 2 has a distal end 4 and an opposite end 7, and the second arm 9 has a distal end 11 and an opposite end 14.

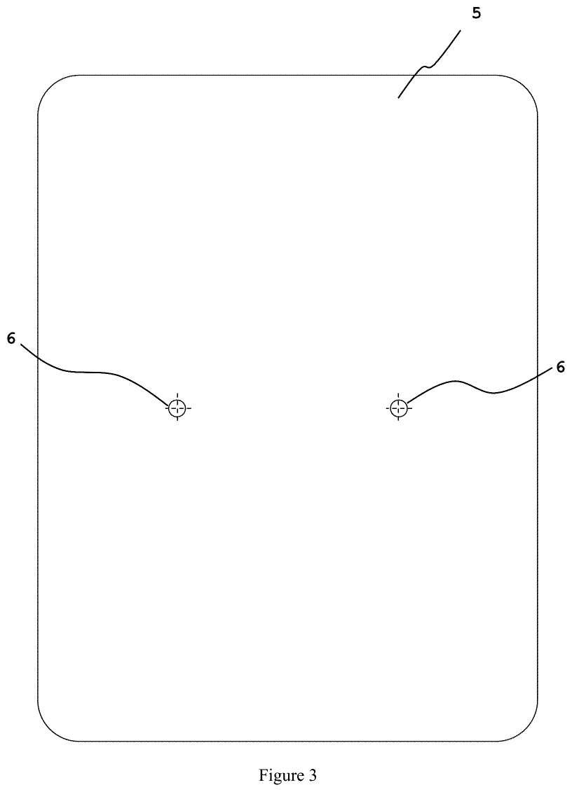

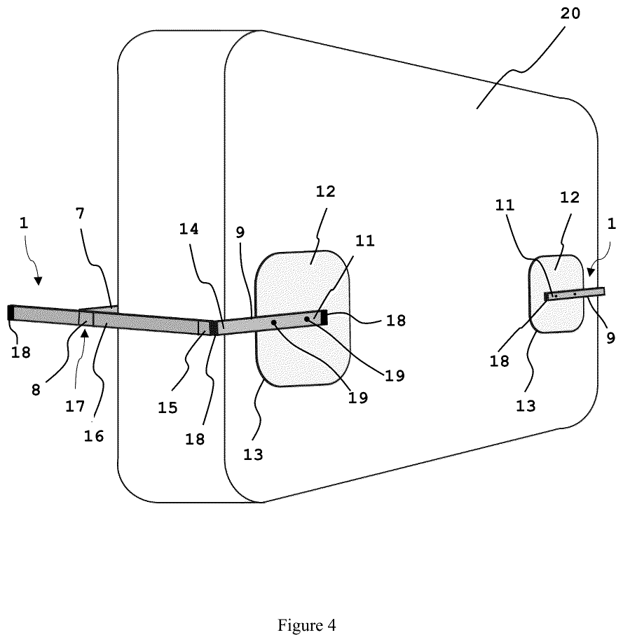

At the distal end 4 of the first arm 2, a paddle 5 is attached. Similarly, a paddle 12 is attached to the distal end 11 of the second arm 9 (see FIG. 4). The paddles 5 and 12 are identical plates having a rectangular shape with rounded corners, as shown in FIG. 3. In a preferable embodiment, each of the paddles 5 and 12 is made from fiberboard or plastic, measuring approximately 7″×9″ (about 17.8×22.9 cm).

Holes 3 for bolts are present in the first arm 2, and corresponding holes 10 for bolts are present in the second arm 9. These holes are configured to facilitate the attachment of the paddles 5 and 13 to the respective arms 2 and 9. The paddles 5 and 12 also have corresponding holes 6 (as shown in FIG. 3) for bolts, through which bolts and nuts 19 are passed (as can be seen in FIG. 4) to attach the paddles 5 and 12 to the arms 2 and 9.

Rubber traction pads 13 are mounted on a surface of each paddle 5 and 13, which is intended to engage the mattress 20, so as to aid in gripping the mattress 20. These traction pads 13 are essential for providing a secure grip on the mattress 20.

Flat head bolts are used to attach the paddles 5 and 12 to the arms 2 and 9 so as to ensure that the profile of the arms 2, 9 and the traction pads 13 remains flush.

The opposite end 7 of the first arm 2 has a female connector 8. Similarly, the opposite end 14 of the second arm 9 has a female connector 15. Each of the female connectors 8 and 15 is a square hollow bar section. A male connector 16 being a square bar is positioned at right angles to the arms, threads through the female connector 15 of the second arm 9, extending from the same side of the second arm 9 as the traction pad 13, and also threads through the female connector 8 of the first arm 2 creating a joint 17 at the opposite end 7 of the first arm 2. FIG. 2 shows the male connector 16 inserted in the female connector 15 of the second arm 9, but disconnected yet from the female connector 8 of the first arm 2.

The paddles 5, 12 are intended for engaging each side of the mattress 20 between the arms 2 and 9, and the male connector 16 and the female connectors 8, 15 are intended to lock the pads 13 together creating support, as can be seen in a perspective view in FIG. 4.

In a preferable embodiment, the male connector is a ⅝″ (about 15.8 mm) steel square bar, approximately 1 foot (about 30.5 cm) in length, and each of the female connectors 9, 17 is a square ¾″ (about 19 mm) box steel section, approximately 1.5″ (about 3.8 cm) in length. The gap between the male connector 16 and the female connector 8, 15 allows the joint 17 to pivot, and upon releasing the clamps 1, the joint 17 will lock due to the metal jamming together and so locking the pads 13 around the mattress.

The exposed distal ends of the clamp have plastic cap ends 18 inserted which act to keep the paddles elevated and away from dirt when placing the mattress carrier clamps on the floor. As shown in FIGS. 1, 2 and 4, the distal ends 4, 11 of the first and second arms 2, 9, a distal end of the male connector 16, and a distal end of the female connector 15 of the second arm 9 are provided with the plastic cap ends 18.

To use the mattress carrier clamps 1, place the mattress 20 on its side, supported by a colleague. Hold one arm 2, 9 of the mattress carrier clamp 1 in each hand, placing them on either side of one end of the mattress 20. Join the arms together and squeeze them to compress the mattress. Upon release, the mattress springs or foam will force the paddles 5, 13 apart, and a jamming action occurs within the joint 17, clamping the mattress between the paddles 5, 13.

A handle is generated from the portion of the male connector 16 that has not passed through the female connectors 8 and 15. This handle length will vary depending on the depth of the mattress being engaged.

To release the mattress carrier clamps, apply equal force to both exposed arms 2, 9 simultaneously at a point furthest from you to counteract the jamming effect. The mattress carrier clamps will then release and can be removed from the mattress 20.

As follows from the above description, the clamps according to the present invention are small and lightweight and can be adjusted and removed quickly.

The mattress carrier clamps can be stored in a bag when not in use.

The arms, handle and clamp can be made from various any strong material, including metal, injection-molded plastic, or carbon fiber. For handling new bare mattresses, a stainless-steel handle version is recommended to prevent tarnishing and enhance hygiene.

Although the present invention has been illustrated and described herein with reference to preferred embodiments and specific examples thereof, the above disclosed subject-matter is to be considered not restrictive and serves to provide a better understanding of the present invention. It will be readily apparent to those of ordinary skill in the art that other embodiments and examples may perform similar functions and/or achieve like results. All such equivalent embodiments and examples are within the scope of the present invention.

1. A mattress carrier clamp comprising:
a pair of arms, each arm having a distal end and an opposing end;
a paddle attached to the distal end of each arm, each paddle having a surface with a rubber traction pad;
opposing male connector and female connectors located at the opposing ends of the arms;
a handle formed by the male connector threading through the female connectors;
wherein the paddles are configured to be placed on either side of one end of a mattress, and when the arms are pressed together, the clamp is configured to grip the mattress and lock around it due to the opposing force of the mattress springs or foam, allowing for lifting and carrying the mattress via the handle.

2. The mattress carrier clamp of claim 1, wherein the male connector is positioned at right angles to the arms.

3. The mattress carrier clamp of claim 1, wherein the arms are made from ¾″ (about 19 mm) square box steel and measure approximately 8″ (about 20.3 cm) in length.

4. The mattress carrier clamp of claim 1, wherein each of the paddles is made from fiberboard or plastic and measures approximately 7″×9″ (about 17.8×22.9 cm).

5. The mattress carrier clamp of claim 1, wherein the male connector is a ⅝″ (about 15.8 mm) steel square bar approximately 1 foot (about 30.5 cm) in length, and each of the female connectors is a square ¾″ (about 19 mm) box steel section approximately 1.5″ (about 3.8 cm) in length.

6. The mattress carrier clamp of claim 1, wherein the clamp is made from materials selected from the group consisting of steel, injection-molded plastic, and carbon fiber.

7. The mattress carrier clamp of claim 1, wherein the clamp comprises plastic cap ends on the distal ends of the arms.

8. The mattress carrier clamp of claim 1, wherein the paddles are attached to the arms using flat head bolts and nuts to keep the profile flush with the traction pads and the arms.

9. A method for lifting and transporting a mattress using the mattress carrier clamp of claim 1, comprising the steps of:
placing the mattress on its side;
positioning the paddles on either side of one end of the mattress;
pressing the arms together to compress the mattress;
releasing the arms to lock the clamps around the mattress;
lifting and transporting the mattress using the handle;
pressing the arms together at a point furthest from a user to release the clamp;
removing the clamp from the mattress.

10. A system for lifting and transporting a mattress between two people, consisting of two mattress carrier clamps of claim 1, one for each end of the mattress.
